(19) United States
(12) Patent Application Publication
(10) Pub. No.: US 2006/0194577 A1
(43) Pub. Date: Aug. 31, 2006

(54) Carrier search methods and related devices

(76) Inventor: Yu-Li Su, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/159,849

(22) Filed: Jun. 23, 2005

Related U.S. Application Data
(60) Provisional application No. 60/656,277, filed on Feb. 25, 2005.

(51) Int. Cl. H04B 1/18; H04Q 7/20; H04M 1/00

(52) U.S. Cl. 455/435.2; 455/552.1

(57) ABSTRACT

Carrier search methods. Band use information is provided in a mobile station. The band use information comprises at least one identification and at least one supported band corresponding to the identification. An operation requesting a carrier search is received, and carriers are searched for from the band if the operation corresponds to the identification.

### BACKGROUND

The present disclosure relates generally to communication management, and, more particularly to carrier search methods and related devices.

GSM (Global System for Mobile communication) system requires MS (Mobile Station) to search all RF (Radio Frequency) channels within bands of operation (supported by MS) for many purposes. The purposes include PLMN (Public Land Mobile Network) selection after switch-on, normal cell selection, PLMN selection from lack of coverage, manual PLMN search, HPLMN (Home Public Land Mobile Network) search, and others.

In ETSI (European Telecommunications Standards Institute) specification, MS may store some information provided by the network, such as BCCH (Broadcast Control Channel) list information or BA_RANGE of a PLMN to speed up the cell selection procedure. MS, however, still cannot avoid the need of an all band carrier search for cell selection. For a multi-band MS, excess power consumption is required to read RF signal level on each RF channel within bands unused for GSM related service. Furthermore, if a band supported by MS is based on a specific protocol, such as CDMA (Code Division Multiple Access), and some base stations of that protocol are in the neighborhood, MS may waste power in identifying BCCH carriers by searching for frequency correction bursts in the band. It is understood that GSM system is an example of the invention, and not limited thereto, the invention can be use in GPRS (General Packet Radio Service), EDGE (Enhanced Data Rate for GSM Evolution), and other systems.

### SUMMARY

Carrier search methods and related devices are provided.

In an exemplary embodiment of a carrier search method, band use information is provided in a mobile station. The band use information comprises at least one identification and at least one supported band corresponding to the identification. An operation requesting a carrier search is received, and carriers are searched for from the band if the operation corresponds to the identification.

In an exemplary embodiment of a carrier search method, band use information is provided in the mobile station. The band use information comprises at least one identification and at lease one corresponding RF channel that the mobile station has camped on previously. An operation requesting a carrier search is received, and carriers are searched for from the band comprising the RF channel if the operation corresponds to the identification.

In an exemplary embodiment of a carrier search method, band use information is provided in the mobile station. The band use information comprises at least one identification and at least one supported band corresponding to the identification. An operation requesting a carrier search is received. It is determined whether the operation is a predetermined operation. If so, carriers are searched for from the band if the operation corresponds to the identification. If not, carriers are searched for from at least one band within at least one band supported by the mobile station.

In an exemplary embodiment of a carrier search method, band use information is provided in the mobile station. The band use information comprises at least one identification and at least one corresponding RF channel that the mobile station has camped on previously. An operation requesting a carrier search is received. It is determined whether the operation is a predetermined operation. If so, carriers are searched for from the band comprising the RF channel if the operation corresponds to the identification. If not, carriers are searched for from at least one band within at least one band supported by the mobile station.

In an exemplary embodiment of a carrier search method, band use information is provided in a mobile station. The band use information comprises at least one identification and at least one supported band corresponding to the identification. An operation requesting a carrier search is received. Carriers are searched for from the band if the operation corresponds to the identification. A mobile network is camped on by the mobile station, and channel information is received therefrom. It is determined whether the channel information corresponds to the identification. If so, the channel information is accumulated to the band use information by adding at least one band supported by the mobile network in the channel information as the bands supported corresponding to the identification.

Carrier search methods may take the form of program code embodied in a tangible media. When the program code is loaded into and executed by a machine, the machine becomes an apparatus for practicing the disclosed method.

### DESCRIPTION OF THE DRAWINGS

The invention will become more fully understood by referring to the following detailed description with reference to the accompanying drawings, wherein:

FIG. 1 is a schematic diagram illustrating an embodiment of a device;

FIG. 2 is a schematic diagram illustrating an embodiment of a format for base use information;

FIG. 3 is a schematic diagram illustrating an embodiment of a format for band used information;

FIG. 4 is a flowchart showing an embodiment of maintenance of band use information;

FIG. 5 is a flowchart showing an embodiment of a procedure for determining whether a carrier search based on band use information is applied for an operation;

FIG. 6 is a flowchart showing an embodiment of a carrier search method;

FIG. 7 is a schematic diagram illustrating an embodiment of a format for band used information;

FIG. 8A is a schematic diagram illustrating an embodiment of a bitmap of derivation indicators; and

FIG. 8B is a schematic diagram illustrating an embodiment of a table of derived bands.

### DESCRIPTION

Carrier search methods and related devices are provided.

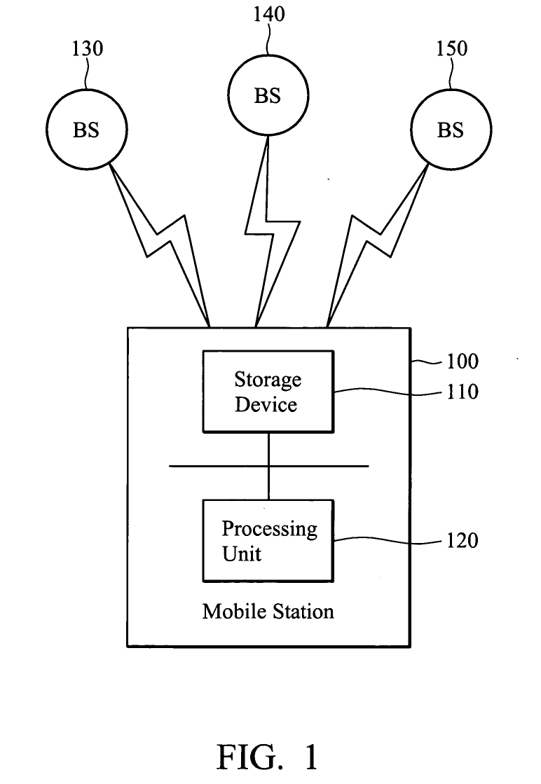

FIG. 1 is a schematic diagram illustrating an embodiment of a device.

The device may be a portable device, such as a mobile station 100. The mobile station 100 performs carrier search on bands within bands of operation thereof, and wirelessly connects to base stations (BS 130, 140, and 150). The bands of operation are bands supported by the mobile station 100. For example, if a multi-band mobile station supports bands 900, 1800, and 1900, the bands of operation are bands 900, 1800, and 1900. It is understood that a mobile station can be set to preferred bands. If preferred bands are selected, the bands of operation are the overlapping portion of the bands supported by the mobile station and the preferred bands. For example, if a multi-band mobile station supports bands 900, 1800, and 1900, the preferred bands are 900, and 1800, the bands of operation are bands 900, and 1800.

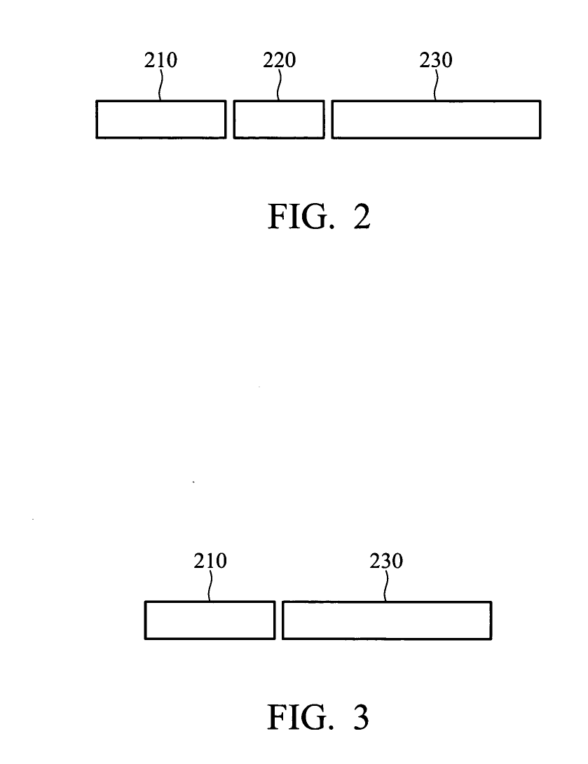

The mobile station 100 comprises a storage device 110 and a processing unit 120. The processing unit 120 performs carrier search of the invention. The storage device 110 stores band use information for carrier searches. The band use information may be mobile network based and country based as shown in FIGS. 2 and 3, respectively. In FIG. 2, the format for mobile network based information comprises three fields of MCC (Mobile Country Code) 210, MNC (Mobile Network Code) 220, and band indicator 230. The combination of MCC 210 and MNC 220 is identification used for identifying a specific mobile network of a country. The band indicator 230 records bands corresponding to the identification. One record of the mobile network based information records bands corresponding to a specific mobile network. In FIG. 3, the format for country based information comprises two fields separately for storing MCC 210 and band indicator 230. MCC 210 is identification used for identifying a specific country. The band indicator 230 records bands corresponding to the identification. One record of the country based information records bands corresponding to a specific country. In some embodiments, MCC 210 is 3 digits, MNC 220 is 2 digits, and band indicator 230 is a bitmap of 4 digits for indicating 850, 900, 1800, and 1900 bands. It is understood that the formats for band use information are not limited thereto.

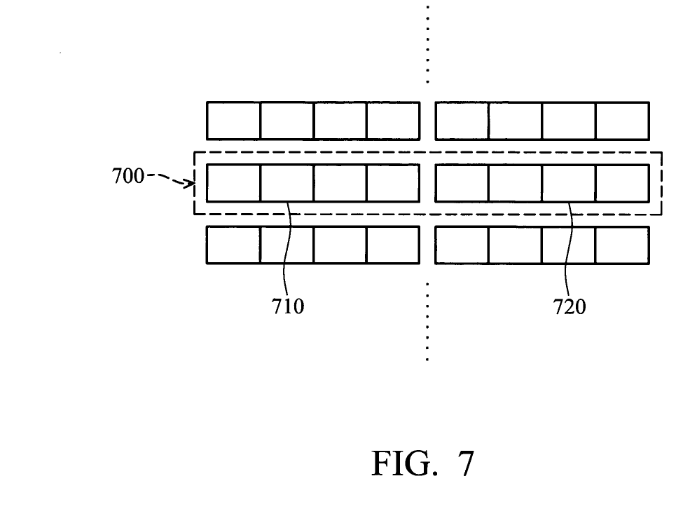

In some embodiments, a memory-efficient look-up table of the band use information is provided. In this table, all known band use information of all countries or mobile networks is saved in the initial load of mobile station in a memory-efficient way. In this table, band indicators are stored, and MCCs/MNCs are indexes for looking up corresponding band indicators. In a 4 bands example, 500 bytes bitmap (0˜499) for 3-digits MCCs (000˜999) band use information is used, as shown in FIG. 7. If MCC 2N is received, the band use information recorded in the first 4 bits (710) of byte N (700) corresponds thereto. If MCC 2N+1 is received, the band use information recorded in the last 4 bits (720) of byte N (700) corresponds thereto. It is understood that the table for MNC is similar to that for MCC, and omitted here. In these embodiments, the memory is efficient because no MCC is saved. Since MCC/MNC is used as an index to acquire band use information, the access is easy. Additionally, since the band use information is initially loaded, there is lower possibility of failure for learning. The learning of band use information is discussed later.

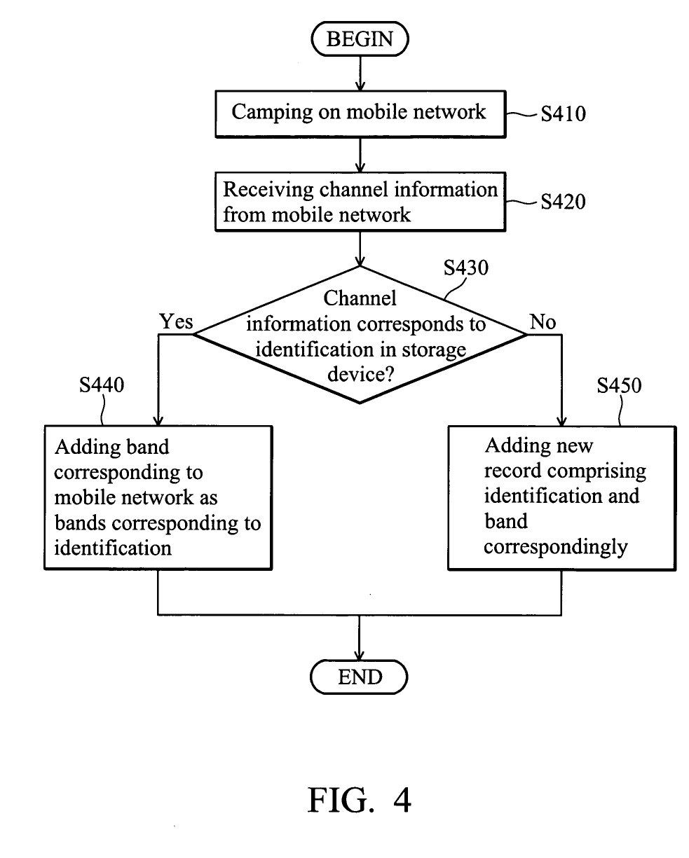

The band use information can be extracted and/or derived from channel information received from base stations. The channel information comprises country and mobile network identification codes, channel description, BCCH list of a cell, and others. In extraction of band use information, the available bands (may be all supported bands or part of supported bands) of a specific mobile network or country can be directly found from the channel information. It is understood that the band use information can be extracted in advance, or during a carrier search. For example, the band use information can be immediately calculated when the channel information is received from base stations. Alternatively, the channel information can be stored, and calculated to obtain the band use information when needed, such as during a carrier search. In the invention, the band use information can be accumulated. The accumulation of band use information is described in FIG. 4.

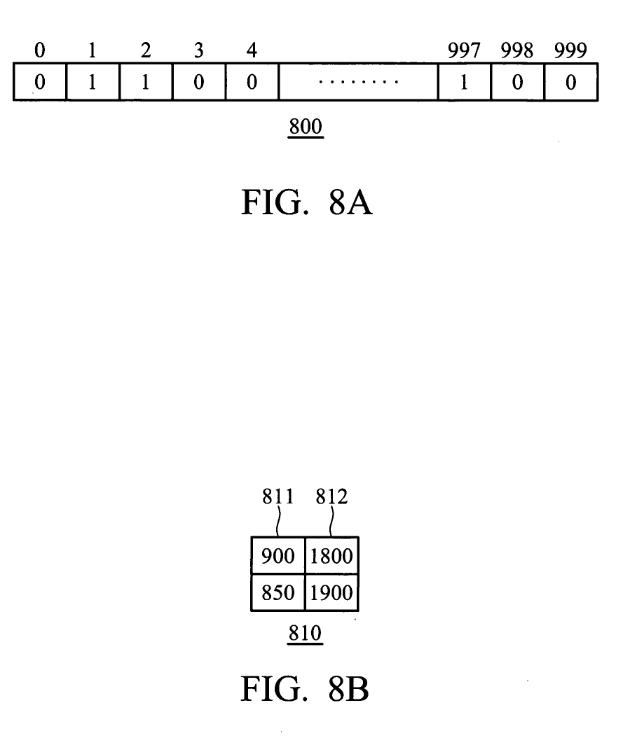

In derivation of band use information, in some embodiments, if a band is supported by a specific mobile network or country, another band is also provided correspondingly. For example, if a band 900 is supported, a band 1800 is supported correspondingly. If a band 850 is supported, a band 1900 is supported correspondingly. In band use information derivation, assisted information can be provided. 1000 countries (MCCs), for example, a 125 bytes (1000 bits) table 800 is provided, as shown in FIG. 8A. Additionally, a table 810 comprising a plurality of first fields 811 and corresponding second fields 812 is provided, as shown in FIG. 8B. MCC is an index for locating a specific indicator representing whether a band supported by the MCC requires to be derived. In table 800, “1” represents a band requires to be derived, and “0” represents no band should be derived. If a MCC and a band supported by the MCC are received, the indicator is checked based on the MCC, and a derived band is retrieved from table 810 according to the supported band. For example, if MCC 1 and a band 900 supported by MCC 1 are received, a band 1800 is derived according to tables 800 and 810. It is understood that the tables 800 and 810 are examples. In implementation, the value in entries of the table 800 may have different definitions. In some embodiments, “1” represents normal two bands (900/1800 or 850/1900) are used in the corresponding country, and “0” represents the corresponding country is not a normal two band country, in which single band or three bands may be used in the country. In some embodiments, “0” represents single band is used in the corresponding country, and “1” represents dual bands or more bands may be used in the corresponding country. In these embodiments, the bands used for limited band scan are extended when the saved information contains one band and the country does not use only single band.

In some embodiments, the band indicator 230 records bands supported by a specific mobile network or country, including but not limited to the bands that a mobile station has camped on previously. It is understood that the bands that a mobile station has camped on can be analyzed from the RF channels that the mobile station has camped on. Further, it is understood that the derivation can be performed when band use information is extracted, or during a carrier search. If the derivation is performed when band use information is extracted, and the bands recorded in the band indicator are bands supported by the mobile network, the derived band can be also accumulated into records (band use information). During the derivation, a record is first located according to a specific MCC/MNC or MCC, and it is determined whether the record only contains one band, and whether dual bands or more bands are used in the MCC/MNC or MCC. If the record contains one band, and dual bands or more bands are used in the MCC/MNC or MCC, the derivation is performed. Otherwise, the derivation is canceled.

If the derivation is performed during a carrier search, the derived band will not be stored into the records (band use information). Similarly, during the derivation, a record is first located according to a specific MCC/MNC or MCC. If it is determined the record contains one band, and dual bands or more bands are used in the MCC/MNC or MCC, the derivation is performed. Otherwise, the derivation is canceled.

FIG. 4 is a flowchart showing an embodiment of maintenance of band use information.

In step S410, a mobile station camps on a cell in a RF channel of a mobile network. In step S420, channel information is received from the RF channel of the mobile network. In step S430, it is determined whether the channel information corresponds to any identification in the storage device. It is understood that the identification may be MCC/MNC or MCC. As described, the channel information comprises country and mobile network identification codes, channel description, BCCH list of a cell, and others, and the band use information comprises MCC, MNC, and band indicator. The determination of step S430 can be performed and a matched record can be retrieved based on MCC/MNC or MCC. If so (Yes in step S430), in step S440, the channel information is analyzed to find a band comprising the RF channel, and the found band is added as a band corresponding to the identification. It is understood that one band may contain several RF channels, and a band can be obtained according to a RF channel. If not (No in step S430), in step S450, a new record is added in the storage device. The record comprises identification and at least one band correspondingly. It is understood that the accumulated bands may be bands supported by the mobile network or country, including but not limited to the band currently camped on. Further, because of limiting memory usage, only certain sets of band use information are stored in the storage device. In some embodiments, if no space for creating a new record, an old record is deleted. For example, the one without being updated for a longest period is replaced by the newly added record.

In some embodiments, the step 440 can be designed to adding the camped on RF channel to be the band use information. Namely, the band information comprises at least one identification and at least one corresponding RF channel that the mobile station has camped on previously. Therefore, when an operation requesting a carrier search is received, and carriers are searched for from the band comprising the RF channel if the operation corresponds to the identification. That is, before the carriers are searched for from the band(s) comprising the RF channel(s), the RF channel(s) in the band use information is/are analyzed to obtain the band(s) comprising the RF channel(s).

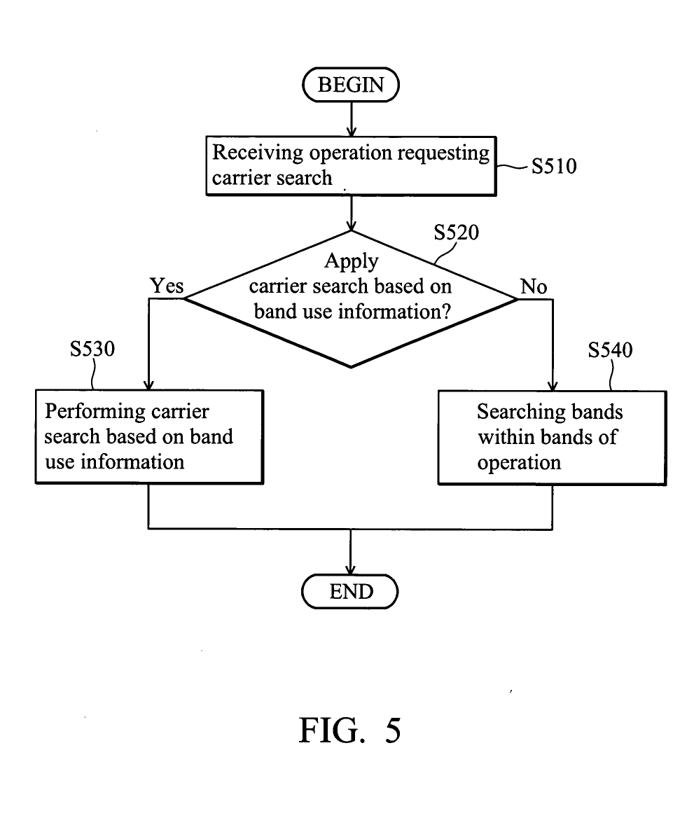

Carrier search is triggered by an operation. The operation comprises PLMN selection after switch on, normal cell selection, PLMN selection from lack of coverage, manual PLMN search, HPLMN search, and others. Carrier searches based on band use information can be determined whether to apply to respective operations. FIG. 5 is a flowchart showing an embodiment of a procedure for determining whether a carrier search based on band use information is applied to an operation. In step S510, an operation requesting a carrier search is received. In step S520, it is determined whether a carrier search based on band use information is required to apply for the operation according to the requirement of the operation and the state of the mobile station. For example, a carrier search based on band use information is applied to PLMN selection after switch on, normal cell selection, PLMN selection from lack of coverage, and HPLMN search. These operations can be set as predetermined operations. Once an operation is received, it is determined whether the operation is one of the predetermined operations. If so, a carrier search based on band use information is applied. It is understood that the predetermined operations are not limited thereto, any operation can be applied with a carrier search based on band use information. If so (Yes in step S520), in step S530, a carrier search based on band use information is performed. If not (No in step S520), in step S540, carriers are searched for from bands within bands of operation. It is understood that the bands of operation are bands supported by the mobile station. The bands of operation are the overlapping portion of the bands supported by the mobile station and preferred bands if the preferred bands are set in the mobile station.

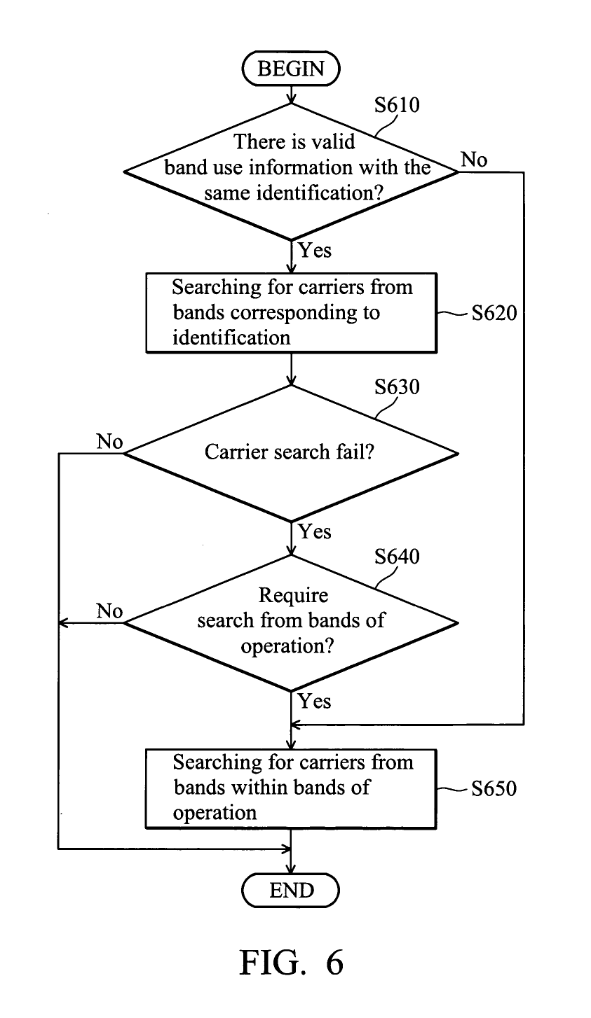

FIG. 6 is a flowchart showing an embodiment of a carrier search method for used in a mobile station.

In step S610, it is examined if there is any valid band use information with the same identification as the one that an operation is associate with. The identification may be a mobile network or country code according to the operation. The selection of band use information of country based or mobile network based depends on the purpose of operation. For example, for HPLMN search, the mobile network based, instead of the country based one shall be used.

If not (No in step S610), in step S650, carriers are searched for from bands within bands of operation. The bands of operation are bands supported by the mobile station. The bands of operation are the overlapping portion of the bands supported by the mobile station and preferred bands if the preferred bands are set in the mobile station. If so (Yes in step S610), in step S620, carriers are searched for from bands corresponding to the identification in the band use information. As described, several implementations are provided. In some embodiments, the band use information can be retrieved from the memory-efficient look-up table. In some embodiments, the band use information can be extracted and/or derived from channel information. The band use information can be extracted when receiving channel information, or during a carrier search. Similarly, the band use information can be derived when receiving channel information, or during a carrier search.

If the band use information is not calculated in advance, the band use information is calculated first before step S620. That is, as described above, in some embodiments, the band information comprises at least one identification and at least one corresponding RF channel that the mobile station has camped on previously, rather than the supported band. Therefore, before S620, the band use information has to be analyzed and calculated so as to obtain the supported band comprising the RF channel in the band use information.

Furthermore, if band derivation is not performed in advance, a band derivation can be performed during the carrier search, and the bands searched for may comprise the derived band. The bands may be bands supported by a specific mobile network or country, including but not limited to the bands that a mobile station has camped on previously. As described, a mobile station camps on a cell on a RF channel, and the bands that a mobile station has camped on represents the bands containing the camped-on RF channel, which can be analyzed and calculated from the camped-on RF channel. If the carrier search is successful (No in step S630), the mobile station camps on a mobile network, and the procedure is completed. If the carrier search fails (Yes in step S630), in step S640, it is determined whether another search is required for the operation. Similarly, the determination depends on the requirement and purpose of the operation and the state of the mobile station. For example, another search may be applied for PLMN selection after switch on, normal cell selection, PLMN selection from lack of coverage, and HPLMN search. It is understood that the operations are not limited thereto. If so (Yes in step S640), in step S650, carriers are searched for from bands within bands of operation. In some embodiments, carriers are searched for from bands within bands of operation except the bands that have been searched. If not (No in step S640), the procedure is completed. In some embodiments, if the bands are bands that a mobile station has camped on previously, the specific identification can be ignored, and carriers are searched for from all bands that the mobile station has camped on previously.

Carrier search methods, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A carrier search method for use in a mobile station, comprising:
providing band use information in the mobile station, in which the band use information comprises at least one identification and at least one supported band corresponding to the identification;
receiving an operation requesting a carrier search; and
searching for carriers from the band if the operation corresponds to the identification.

2. The method of claim 1 wherein the identification corresponds to a mobile network.

3. The method of claim 1 wherein the identification corresponds to a country.

4. The method of claim 1 further comprising:
camping on a mobile network by the mobile station;
receiving channel information from the mobile network; and
accumulating the channel information to the band use information.

5. The method of claim 4 further comprising:
determining whether the channel information corresponds to the identification; and
if so, adding at least one band supported by the mobile network as the bands supported corresponding to the identification.

6. The method of claim 1 further comprising searching for carriers from bands within bands supported by the mobile station except the supported band corresponding to the identification if the carrier search fails.

7. The method of claim 1 further comprising deriving a specific supported band according to the identification and the corresponding supported band.

8. The method of claim 7 further comprising:
providing a first table comprising a plurality of fields, respectively recording a indicator representing whether a band supported by the identification requires to be derived, in which the identification is an index to locate the indicator; and
providing a second table comprising a plurality of first fields and corresponding second fields, in which the first field records the supported band corresponding to the identification and the second field records the derived supported band,
wherein the derivation is performed according to the identification, and the first and second tables.

9. The method of claim 7 further comprising deriving a specific supported band according to the identification and the corresponding supported band if only one band corresponding to the identification, and not single band is used for the identification.

10. A carrier search method for use in a mobile station, comprising:
providing band use information in the mobile station, in which the band use information comprises at least one identification and at least one corresponding RF channel camped on previously by the mobile station;
receiving an operation requesting a carrier search; and
searching for carriers from the band comprising the RF channel if the operation corresponds to the identification.

11. The method of claim 10 wherein the identification corresponds to a mobile network.

12. The method of claim 10 wherein the identification corresponds to a country.

13. The method of claim 10 further comprising:
camping on a mobile network by the mobile station;
receiving channel information from the mobile network; and
accumulating the channel information to the band use information.

14. The method of claim 13 further comprising:
determining whether the channel information corresponds to the identification; and
if so, adding a RF channel currently camped on as the RF channels corresponding to the identification.

15. A carrier search method for use in a mobile station, comprising:
providing band use information in the mobile station, in which the band use information comprises at least one identification and at least one supported band corresponding to the identification;
receiving an operation requesting a carrier search;
determining whether the operation is a predetermined operation;
if so, searching for carriers from the band if the operation corresponds to the identification; and
if not, searching for carriers from at least one band within at least one band supported by the mobile station.

16. The method of claim 15 wherein the predetermined operation comprises PLMN (Public Land Mobile Network) selection after switch-on, normal cell selection, PLMN selection from lack of coverage, or HPLMN (Home Public Land Mobile Network) selection.

17. A carrier search method for use in a mobile station, comprising:
providing band use information in the mobile station, in which the band use information comprises at least one identification and at least one corresponding RF channel camped on previously by the mobile station;
receiving an operation requesting a carrier search;
determining whether the operation is a predetermined operation;
if so, searching for carriers from the band comprising the RF channel if the operation corresponds to the identification; and
if not, searching for carriers from at least one band within at least one band supported by the mobile station.

18. The method of claim 17 wherein the predetermined operation comprises PLMN (Public Land Mobile Network) selection after switch-on, normal cell selection, PLMN selection from lack of coverage, or HPLMN (Home Public Land Mobile Network) selection.

19. A device, comprising:
means for providing band use information in a mobile station, in which the band use information comprises at least one identification and at least one supported band corresponding to the identification;
means for receiving an operation requesting a carrier search; and
means for searching for carriers from the band if the operation corresponds to the identification.

20. A device, comprising:
means for providing band use information in a mobile station, in which the band use information comprises at least one identification and at least one corresponding RF channel camped on previously by the mobile station;
means for receiving an operation requesting a carrier search; and
means for searching for carriers from the band comprising the RF channel if the operation corresponds to the identification.

21. A device, comprising:
means for providing band use information in a mobile station, in which the band use information comprises at least one identification and at least one supported band corresponding to the identification;
means for receiving an operation requesting a carrier search;
means for determining whether the operation is a predetermined operation;
if so, means for searching for carriers from the band if the operation corresponds to the identification; and
if not, means for searching for carriers from at least one band within at least one band supported by the mobile station.

22. A device, comprising:
means for providing band use information in a mobile station, in which the band use information comprises at least one identification and at least one corresponding RF channel that the mobile station has camped on previously;
means for receiving an operation requesting a carrier search;
means for determining whether the operation is a predetermined operation;
if so, means for searching for carriers from the band comprising the RF channel if the operation corresponds to the identification; and
if not, means for searching for carriers from at least one band within at least one band supported by the mobile station.

23. A carrier search method for use in a mobile station, comprising:
receiving an operation requesting a carrier search;
determining whether the operation requires a limited band search;
if not, searching for carriers from all band within bands supported by the mobile station; and
if so, searching for carriers from parts of the bands.

24. A method for use in a mobile station, comprising:
camping on a mobile network by the mobile station;
receiving channel information from the mobile network; and
accumulating the channel information to band use information,
wherein the band use information is used for a limited band search.

25. The method of claim 24, wherein the band use information comprises at least one identification and at least one supported band corresponding to the identification.

26. The method of claim 24, wherein the band use information comprises at least one identification and at least one corresponding RF channel that the mobile station has camped on previously.
